(19) United States
(12) Patent Application Publication
(10) Pub. No.: US 2003/0026089 A1
(43) Pub. Date: Feb. 6, 2003

(54) Radiating wearing object

(76) Inventor: Yi-Chuan Hsu, Miaoli City (TW)

Correspondence Address: BRUCE H. TROXELL, SUITE 1404, 5205 LEESBURG PIKE, FALLS CHURCH, VA, 22041, US

(21) Appl. No.: 10/075,228

(22) Filed: Feb. 15, 2002

(30) Foreign Application Priority Data
Aug. 6, 2001 (TW) 90213460

(51) Int. Cl. F21K 2/00; F21V 21/08

(52) U.S. Cl. 362/103; 362/34

(57) ABSTRACT

A radiating wearing object, wherein the wearing object is to cover a specific potion of body, such as shoe, clothes or hat etc., which comprises a main body and a plurality of radiating members. The radiating members have chemical compositions therein to provide radiation from chemical reaction. The main body disposed with a plurality of secure segments thereon for detachable securing the radiating members on the surface of the main body, whereby user can arrange the radiating member into a specific icon or a character and can make the radiating member to radiate in a dark environment for capturing people's attention.

### FIELD OF THE INVENTION

The present invention relates generally to a wearing object, which is to cover a specific potion of body, and more particularly to a radiating wearing object.

### BACKGROUND OF THE INVENTION

The everyday wearing objects, such as footwear, clothes and hats etc., are to cover body for against cold, protecting body from injure, or making he/she looking pretty. Some wearing objects dispose radiating means thereon for security or just for fun. In the prior art, there were radiation means and light reflection means to be disposed on the wearing objects.

For the light reflection means, there are light reflecting pieces or light reflecting films disposed on the wearing object for reflecting the exterior light. So, the light reflection means will not function in a fully dark environment. For the radiation means, the prior art usually pick the light-emitting diode (LED) for providing radiation. The LED can provide light in any environment, but there must be a power (battery) and a circuit to be set on the wearing object for working with the LED. It highly increases the cost of the wearing object, and more particularly, the circuit sometime may not be function or the battery may be electric leakage.

Furthermore, users do not need the clothes or shoes to radiate all the time. Just in a particular place or time they need the clothes or shoes to radiate. So, the prior art further need a switch device or a sensor device to turn on the radiation. But it will make the radiation device more complex.

### SUMMARY OF THE INVENTION

The primary objective of the invention is to provide a radiating wearing object, which has a simple structure to provide radiation as user need and without the drawbacks described above.

According to the objective of the invention, a radiating wearing object comprising a main body, which is to cover a specific potion of body. At least one radiating member, which has chemical compositions therein to provide radiation from a chemical reaction. The radiating member is detachable secured on the main body, whereby user can arrange the radiating member into a specific icon or a character and can make the radiating member to radiate in a dark environment for capturing people's attention.

### BRIEF DESCRIPTION OF THE DRAWINGS

FIG. 1 is the structure sketch of the first prefer embodiment of the present invention, showing radiating members installed on a shoe.

FIG. 2 is the structure sketch of the first prefer embodiment of the present invention, showing radiating members being arranged into a specific shape.

FIG. 3 shows another type of secure segments of the first prefer embodiment of the present invention.

FIG. 4 is the structure sketch of the second prefer embodiment of the present invention, showing radiating members installed on a shoe.

FIG. 5 is the structure sketch of the third prefer embodiment of the present invention, showing radiating members installed on a clothes.

FIG. 6 is the structure sketch of the fourth prefer embodiment of the present invention, showing radiating members installed on a hat.

### DETAIL DESCRIPTION OF THE INVENTION

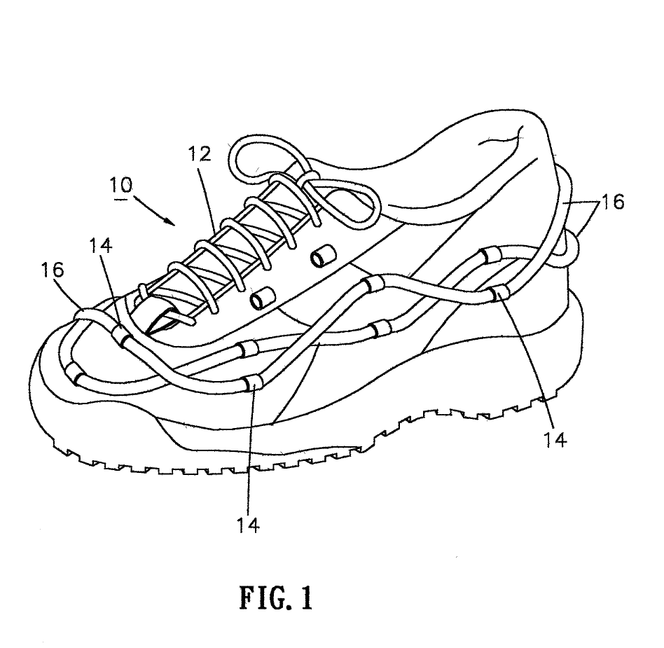

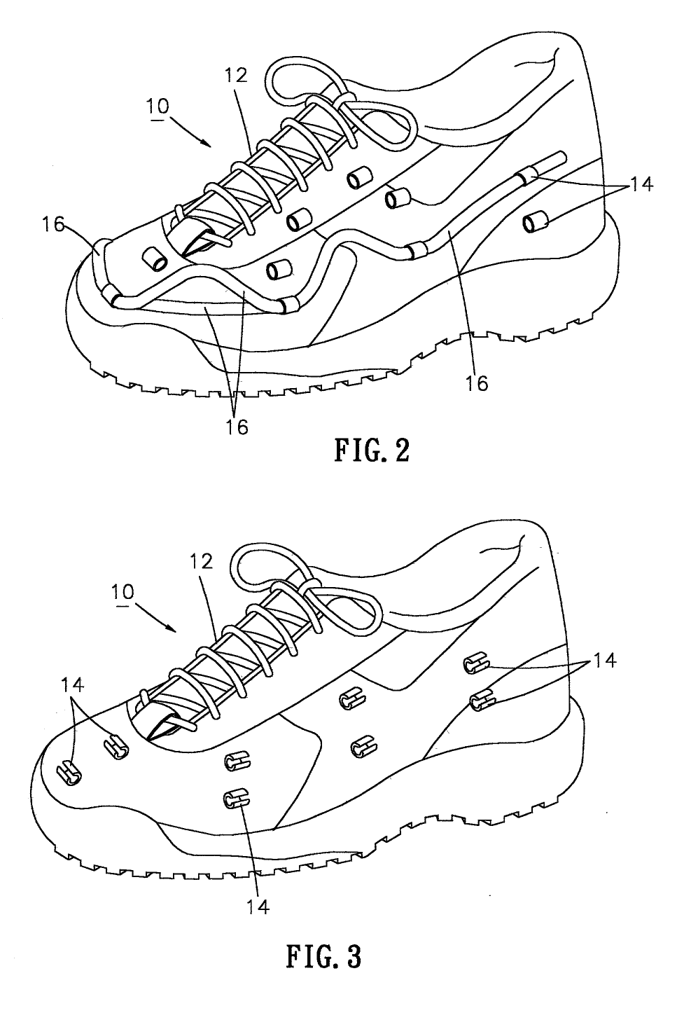

Please refer to FIG. 1 and FIG. 2, the first prefer embodiment of the present invention provides a shoe 10 to be the wearing object, which has a main body 12. A plurality of soft tubes 14 are disposed on the surface of the main body 12 of the shoe 10. The tubes 14 are sewed or stuck on the main body 12 and arranged in predetermined locations. A plurality of radiating members 16 are secured at the tubes 14. The radiating members 16 are flexible bars, which have hydrogen peroxide and oxalic acid therein. When mixing the chemical compositions, the radiating members 16 can provide radiation for a period of time. The radiating members 16 interfered receive in the tubes 14 to be secured at the surface of the main body 12 of the shoe 10. Whereby when users join a party, they can install the radiating members 16 into the tubes 14 and make the radiating members 16 radiating for capturing people attention or just for fun.

When users do not want to provide radiation or the illumination of the radiating members 16 decreased, they can just pull out the radiating members 16 from the tubes 14 or replace new radiating members 16 to provide radiation again. The way of installing and disassembling the radiating members 16 of the present invention is very easy.

User can arrange the shapes of the radiating members 16 into a specific shape, such as icons or characters, as he/she wants. FIG. 2 shows the radiating members 16 being arranged to the characters of A and N. And the shapes of the radiating members 16 can be changed by user.

The secure segments (the tubes 14) of the present invention can be made into different type, as shown in FIG. 3, the secure segments are C-rings 14, which also can secure the radiating members 16. And the C-rings 14 can be paint a variety of colors to make the shoe 10 looking fancier.

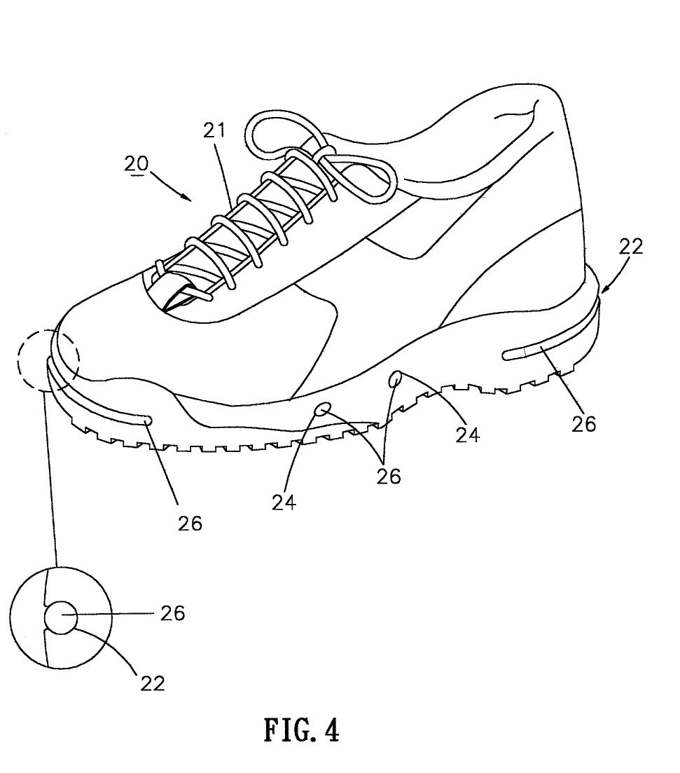

Please refer to FIG. 4, a second prefer embodiment of the present invention also provides a shoe 20 as the wearing object. The shoe 20 has a main body 21, which has two slots 22 at front side and back side of the sole of the shoe 20 and has two holes 24 at the lateral side of the sloe of the shoe 20. Radiating members 26 are interfered receiving in the slots 22 and the holes 24 to be secured at the main body 21 of the shoe 20. The dimensions of the slots 22 and the holes 24 are smaller than the outer diameters of the radiating members 26. Because of the sole of the shoe 20 is made from elastic material, the radiating members 26 can be squeezed into the slots 22 and the holes 24 and will not escape.

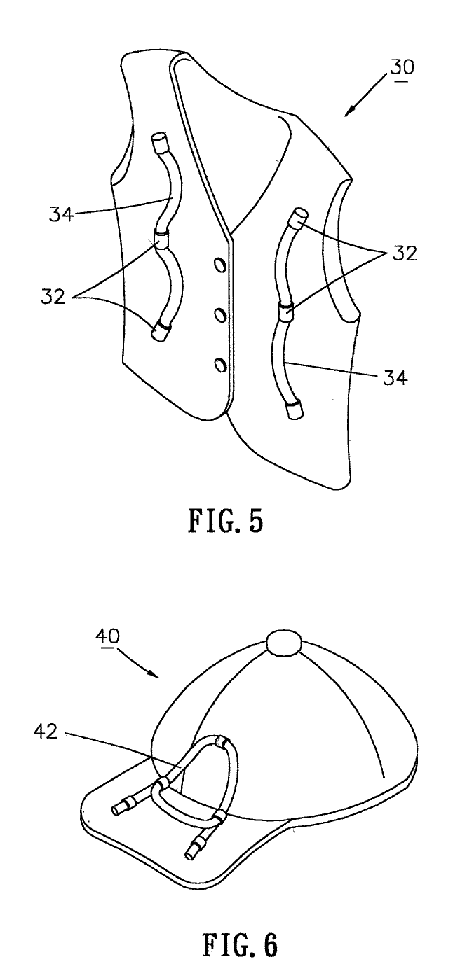

FIG. 5 shows a third embodiment of the present invention. In this prefer embodiment, we provide a clothes 30 to be the wearing object, which has tube-shaped secure segments 32 and radiating members 34 disposed thereon as described above.

FIG. 6 shows a fourth embodiment of the present invention. In this prefer embodiment, we provide a hat 40 to be the wearing object, which secured radiating members 34 thereon and arranged into an A character.

User can wear the shoes 10 of the first prefer embodiment, the clothes 30 of the third prefer embodiment and the hat 40 of the fourth embodiment on to provide radiation at variety of positions.

It has to mention here, the secure segments of the present invention are to secure the radiating members on the wearing object. There are some types of secure means that we did not mention in the specification, such as Velcro or Post-it etc., should be applied in the present invention.

What is claimed is:

1. A radiating wearing object comprising a main body, which is to cover a specific potion of body; at least one radiating member, which has chemical compositions therein to provide radiation from a chemical reaction, and means for detachable securing said radiating member on said main body; whereby user can arrange said radiating member into a specific icon or a character and can make said radiating member to radiate in a dark environment for capturing people's attention.

2. The radiating wearing object as defined in claim 1, wherein the wearing object being a shoe.

3. The radiating wearing object as defined in claim 1, wherein the wearing object being a clothes.

4. The radiating wearing object as defined in claim 1, wherein the wearing object being a hat.

5. The radiating wearing object as defined in claim 1, wherein said radiating member being bar element.

6. The radiating wearing object as defined in claim 1, wherein comprising at least one tube provided on said main body; said radiating member receiving in said tube to be secured at said main body.

7. The radiation device for a wearing object as defined in claim 1, wherein comprising at least one hole provided on said main body; said radiating member receiving in said hole to be secured at said main body.

8. The radiation device for a wearing object as defined in claim 1, wherein comprising at least one C-ring provided on said main body; said radiating member receiving in said C-ring to be secured at said main body.

9. The radiation device for a wearing object as defined in claim 1, wherein comprising at least one slot provided on said main body; said radiating member receiving in said slot be to secured at said main body.
